(19) United States
(12) Patent Application Publication
(10) Pub. No.: US 2015/0213168 A1
(43) Pub. Date: Jul. 30, 2015

(54) LOGIC EQUIVALENCY CHECK USING VECTOR STREAM EVENT SIMULATION

(71) Applicant: Mentor Graphics Corporation, Wilsonville, OR (US)

(72) Inventor: Robert Bencivenga, Westford, MA (US)

(73) Assignee: Mentor Graphics Corporation, Wilsonville, OR (US)

(21) Appl. No.: 14/168,341

(22) Filed: Jan. 30, 2014

(51) Int. Cl. G06F 17/50

(52) U.S. Cl. CPC G06F 17/5022; G06F 17/5031; G06F 17/5045

(57) ABSTRACT

This application discloses a system implementing tools and mechanisms to develop a vector stream for each input of a circuit design. Each vector stream can be configured to identify one or more operations in the circuit design having an output that depends on a corresponding input of the circuit design. The tools and mechanisms can select different vector streams to utilize for simulation of the circuit design based on value changes in a series of test vectors, and simulate the circuit design by performing operations identified by the selected vector streams with values from the corresponding test vectors. The tools and mechanisms can generate the series of test vectors with a pattern generator, which may be in a grey code sequence. The tools and mechanisms can determine whether the circuit design is equivalent to another circuit design by comparing the simulation results of the two circuit designs.

### TECHNICAL FIELD

This application is generally related to electronic design automation and, more specifically, to logic equivalency check using vector stream event simulation.

### BACKGROUND

Microdevices, such as integrated microcircuits and microelectromechanical systems (MEMS), are used in a variety of products, from automobiles to microwaves to personal computers. Designing and fabricating microdevices typically involves many steps, known as a “design flow.” The particular steps of a design flow often are dependent upon the type of microcircuit, its complexity, the design team, and the microdevice fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows for integrated microcircuits. Initially, the specification for a new circuit is transformed into a logical design, sometimes referred to as a register transfer level (RTL) description of the circuit. With this logical design, the circuit can be described in terms of both the exchange of signals between hardware registers and the logical operations that can be performed on those signals. The logical design typically employs a Hardware Design Language (HDL), such as the Very high speed integrated circuit Hardware Design Language (VHDL). As part of the creation of a logical design, a designer will also implement a place-and-route process to determine the placement of the various portions of the circuit, along with an initial routing of interconnections between those portions. The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices, such as transistors, resistors, and capacitors, which will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design can be again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components, e.g., contacts, gates, etc., and place them in a design area. These groups of geometric elements may be custom designed, selected from a library of previously-created designs, or some combination of both. Once the groups of geometric elements representing circuit device components have been placed, geometric elements representing connection lines then are then placed between these geometric elements according to the predetermined route. These lines will form the wiring used to interconnect the electronic devices.

Typically, a designer will perform a number of analyses on the resulting layout design data. For example, with integrated circuits, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc. For example, the design flow process may include one or more resolution enhancement technique (RET) processes, that modify the layout design data to improve the usable resolution of the reticle or mask created from the design in a photolithographic manufacturing process.

After the layout design has been finalized, it is converted into a format that can be employed by a mask or reticle writing tool to create a mask or reticle for use in a photolithographic manufacturing process. The written masks or reticles then can be used in a photolithographic process to expose selected areas of a wafer to light or other radiation in order to produce the desired integrated microdevice structures on the wafer.

As discussed above, at various stages of the design flow, the design is transformed into a different representation, for example, the transformation of the design from an RTL representation to a gate-level netlist representation during synthesis, the transformation of the gate-level netlist to a physical design layout, or the like. These transformations are intended to convert the design into an equivalent representation, albeit at a different level of abstraction than the previous representation of the design, which retains the functionality of the design.

To help ensure that a transformation did not alter the functionality of the design, the different design representations can be simulated to determine whether they are equivalent, for example, using formal techniques provided by a Binary Decision Diagram (BDD) tool, a Satisfiability Prover (SAT) tool, an Automatic Test Pattern Generator (ATPG) tool, or the like. While these formal techniques can be very powerful in verifying equivalency of many different types of designs, for certain digital logic functions being compared for equivalency, such as arithmetic multipliers, the formal techniques often abort attempts to verify equivalency or require weeks of effort to determine whether the designs are equivalent.

### SUMMARY

This application discloses tools and mechanisms for exhaustive event simulation for equivalency checking. An equivalence check tool can generate test stimulus, such as an exhaustive series of test vectors, each having a set of bits corresponding to a set of inputs in a circuit design. The equivalence check tool can simulate the circuit design with the test stimulus and then compare the simulation results with those of another circuit design to determine whether the two circuit designs are equivalent.

The equivalence check tool can speed-up circuit design simulation by leveraging results from previous simulations of the circuit design and selectively performing partial simulations for certain test vectors, which allows the equivalence check tool to generate simulation results or waveform data for the circuit design quickly and efficiently. In some embodiments, the equivalence check tool can analyze the circuit design to determine which portions of the circuit design are affected and left unaffected for each input of the circuit design, develop operational instructions or vector streams corresponding to affected circuit design portions for each input, and then selectively simulate one or more vector streams when a value of their corresponding input has changed relative to a previous simulation with the series of test vectors. By ordering the series of test vectors to reduce value changes between adjacent test vectors, and by correlating vector streams to particular bits in the test vectors, the equivalence check tool can efficiently simulate the circuit design.

### DESCRIPTION OF THE DRAWINGS

FIGS. 1 and 2 illustrate an example of a computer system of the type that may be used to implement various embodiments of the invention.

FIG. 3 illustrates an example equivalence check tool according to various embodiments of the invention.

FIG. 4 illustrates an example vector generation unit in an equivalence check tool according to various embodiments of the invention.

FIG. 5 illustrates a flowchart showing an example implementation of exhaustive event simulation for equivalence checking according to various embodiments of the invention.

FIGS. 6A-6C illustrate an example implementation of exhaustive event simulation for equivalence checking according to various embodiments of the invention.

### DETAILED DESCRIPTION

### Illustrative Operating Environment

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads.

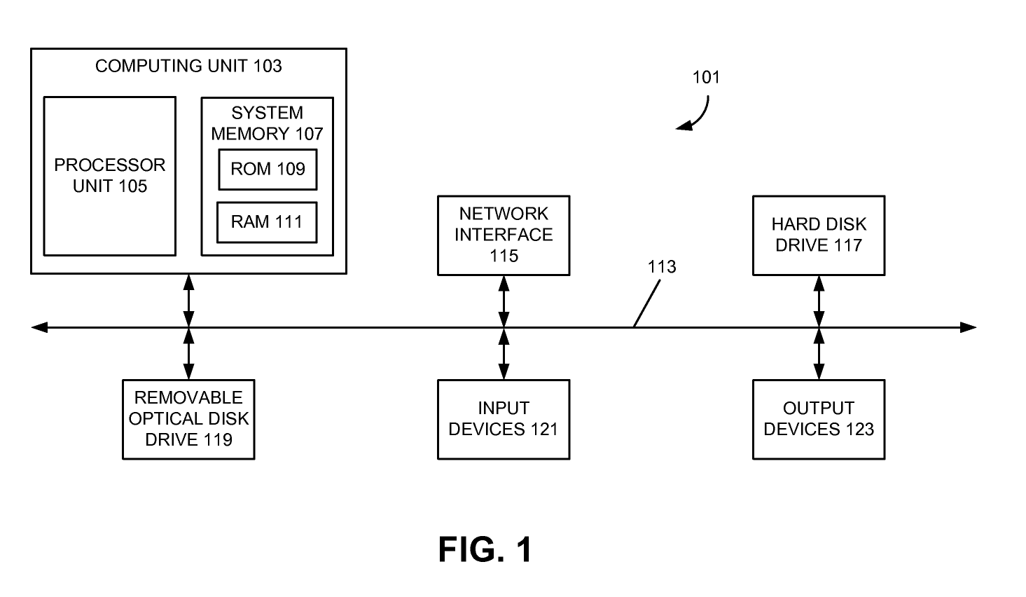

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

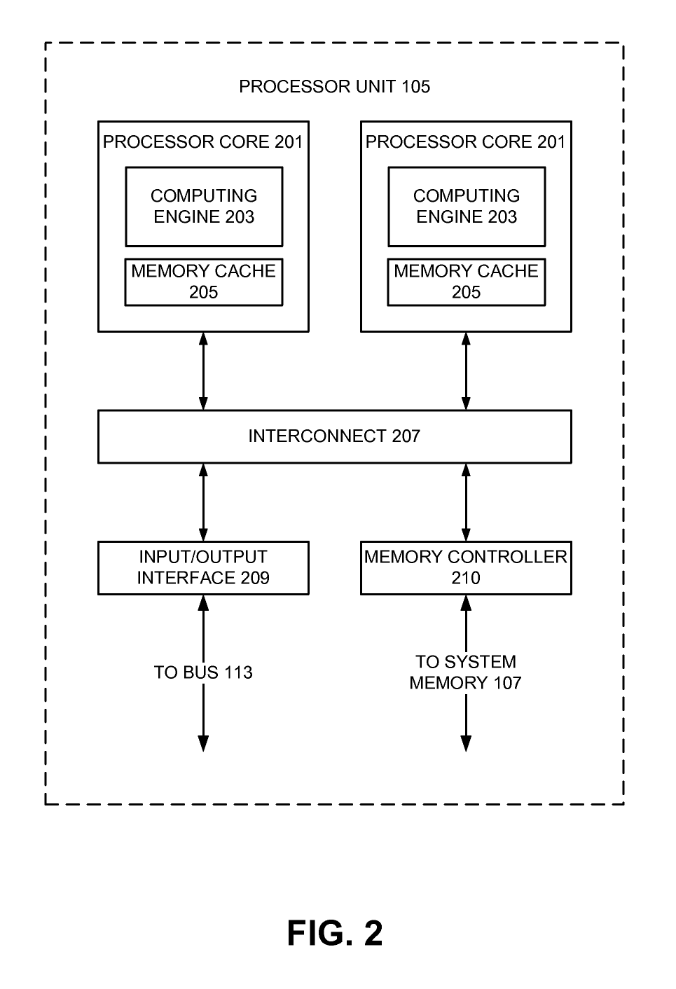

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 113. Similarly, the memory controller 211 controls the exchange of information between the processor unit 201 and the system memory 107. With some implementations of the invention, the processor units 201 may include additional components, such as a high-level cache memory accessible shared by the processor cores 201.

It also should be appreciated that the description of the computer network illustrated in FIG. 1 and FIG. 2 is provided as an example only, and it not intended to suggest any limitation as to the scope of use or functionality of alternate embodiments of the invention.

### Exhaustive Event Simulation for Equivalence Check

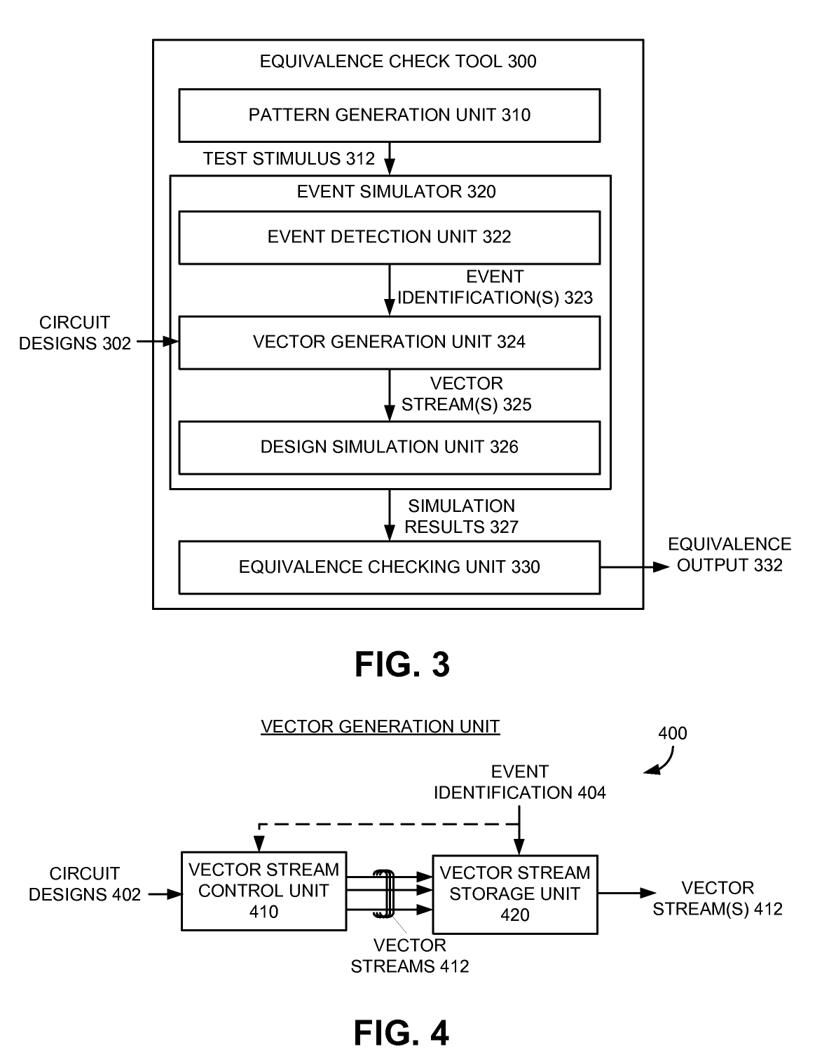

FIG. 3 illustrates an example equivalence check tool 300 according to various embodiments of the invention. Referring to FIG. 3, the equivalence check tool 300 can include a pattern generation unit 310 to generate test stimulus 312 for use in simulating circuit designs 302. The test stimulus 312 can include a series of test vectors, each having a set of bits corresponding to a set of inputs in each of the circuit designs 302. For example, when a circuit design includes three inputs, the pattern generation unit 310 can generate a stream of 3-bit test vectors—with a value of the first bit being provided to a first input of the circuit design during simulation, a value of the second bit being provided to a second input of the circuit design during simulation, and a value of the third bit being provided to a third input of the circuit design during simulation.

The test stimulus 312 can include an exhaustive list of the test vectors, for example, every possible test vector for a given number of bits in those test vectors. The number of test vectors generated by the pattern generation unit 310 can be determined with Equation 1.

TV_{N}=2^{N} Equation 1:

TV_{N} can be a number of test vectors in the exhaustive list of test vectors, and a variable N can be the number of bits in the test vectors. The pattern generation unit 310 can generate an exhaustive list or stream of test vectors in a particular order, for example, in a standard binary counting order, such as 0, 1, 2, 3, etc., in an order having adjacent test vectors having one bit different, such as a grey code ordering scheme, or the like. As will be discussed below, the ordering of the test vectors can provide simulation efficiency when utilizing an event simulator 300 configured to selectively simulate portions of the circuit designs 302 based on value changes in the stream of test vectors.

The equivalence check tool 300 can include an event simulator 320 to simulate the circuit designs 302 with the test stimulus 312, and generate corresponding simulation results 327. The equivalence check tool 300 can include an equivalence checking unit 330 to compare the simulation results 327 for different circuit designs 302 against each other to determine whether the different circuit designs 302 are equivalent to each other. The equivalence checking unit 330 can generate an equivalence output 332 based on the equivalence determination, which can indicate whether the different circuit designs 302 are equivalent to each other.

The event simulator 320 can include an event detection unit 322 to detect changes or differences in adjacent test vectors in test stimulus 312, and generate event identifications 323 in response to the detected changes. For example, the event detection unit 322 can identify which bit or combination of bits in a test vector have changed relative to a previously-received test vector, which may be a temporally-adjacent test vector, and generate the event identification 323 to identify which bit or combination of bits changed.

The event simulator 320 can include a vector generation unit 324 to identify, for each circuit design input, portions of the circuit designs 302 that depend on a value of a corresponding input. Since the circuit designs 302 can model functionality, logic operations, gates, transistors, or the like, which depend on a subset of the inputs of the circuit designs 302, i.e., portions of the circuit design may have an output that is uninfluenced by a value of one or more inputs, the vector generation unit 324 can identify, for each input, those portions of the circuit designs 302 that can depend on a value of a corresponding input. For example, when a circuit design has two inputs, the vector generation unit 324 can identify a first portion of the circuit design has an output that could change depending on a value of a first input, and identify a second portion of the circuit design has an output that could change depending on a value of a second input. The first and second portions need not be mutually-exclusive, as at least a portion of the first portion can overlap with the second portion.

In some embodiments, the vector generation unit 324 can utilize the identified portions of the circuit designs 302 to develop corresponding vector streams 325 for each input of circuit designs 302. These vector streams 325 can model the operations present in the identified portions of the circuit designs 302, and, in some cases, also identify their corresponding operands. The vector streams 325 can be arranged, for example, in serial fashion, to allow the event simulator 320 the ability to simulate the identified portion of the circuit designs 302 with the test vectors as input to at least some of the operands. Embodiments of circuit design apportioning and vector stream generation will be described below in greater detail.

The vector generation unit 324 can select one or more of the vector streams 325 based on the event identification 323 from the event detection unit 322. For example, when the event identification 323 indicates that a fifth-bit changed in a test vector compared to a previous test vector simulated by the event simulator 320, the vector generation unit 324 can select a vector stream 325 corresponding to an input configured to receive the fifth-bit during simulation and output the selected vector stream 325 to a design simulation unit 326. The design simulation unit 326 can simulate the selected vector stream 325 with the test vector utilized by the event detection unit 326 to generate the event identification 323 that prompted the selection of the vector stream 325. The design simulation unit 326 can generate the simulation results 327 from the simulation of the selected vector stream 325, which, in some embodiments, can include combining the results from simulating the selected vector stream 325 with unaffected results from a previous circuit design simulation.

Since the design simulation unit 326 can simulate less than the entire circuit design for many test vectors, for example, depending on a number of bit-value changes between adjacent test vectors, the equivalence check tool 300 can include several techniques to improve simulation efficiency. The first technique involves ordering the test vectors to minimize the number of bit-value changes between adjacent test vectors, for example, down to a single bit-value change, while still providing an exhaustive list of test vectors in the test stimulus 312. As discussed above, the pattern generation unit 310 can implement a grey code ordering scheme, which can order the generation of test vectors such that a single bit-value changes between each test vector. The number of bit-changes in an exhaustive list of test vectors can be determined with the following equation.

Grey Code Sequence Bit Changes=2^{N}−1 Equation 2:

The variable N corresponds to the number of bits in the test vectors. Thus, for example, when you have an 8-bit test vector, the grey code sequence includes 256 total test vectors, and 255 bit-value changes between test vectors.

Binary Count Sequence Bit Changes=2^{(N+1)}−(N+2) Equation 3:

The variable N corresponds to the number of bits in the test vectors. Thus, for example, when you have an 8-bit test vector, the binary count sequence includes 256 total test vectors, and 502 bit-value changes between test vectors. In other words, by utilizing a grey code sequence in the pattern generation unit 310 in the 8-bit test vector example, the design simulation unit 326 can simulate or process 247 fewer vector streams 325 for each circuit design than when utilizing the binary count sequence for an 8-bit test vector. As the number of bits in the test vectors increases, the design simulation unit 326 can simulate approximately half as many vector streams 325 in the simulation of each circuit design 302.

The second technique to improve simulation efficiency leverages a non-symmetrical distribution of bit-changes in a test vector sequence to prioritize simulation of vector streams 325 that the design simulation unit 326 can process more quickly, such as those with fewer operations. For example, a grey code sequence of a 4-bit test vector can include 1 bit-value change for the most significant bit, 2 bit-value changes for the second most significant bit, 4 bit-value changes for the second least significant bit, and 8 bit-value changes for the least significant bit. The event simulator 320 can correlate bits from the test vectors to particular inputs of the circuit designs 302 such that inputs corresponding to the smaller or quicker-to-process vector streams 325 can be assigned to receive bits in the test vectors having more bit-value changes, while that inputs corresponding to the larger or slower-to-process vector streams 325 can be assigned to receive bits in the test vectors having fewer bit-value changes. In some embodiments, the event detection unit 322, the vector generation unit 324, or a combination thereof, can determine or estimate a simulation time for each vector stream 325 and assign test vector bits to inputs of the circuit designs based on the determined or estimated vector stream 325 simulation times.

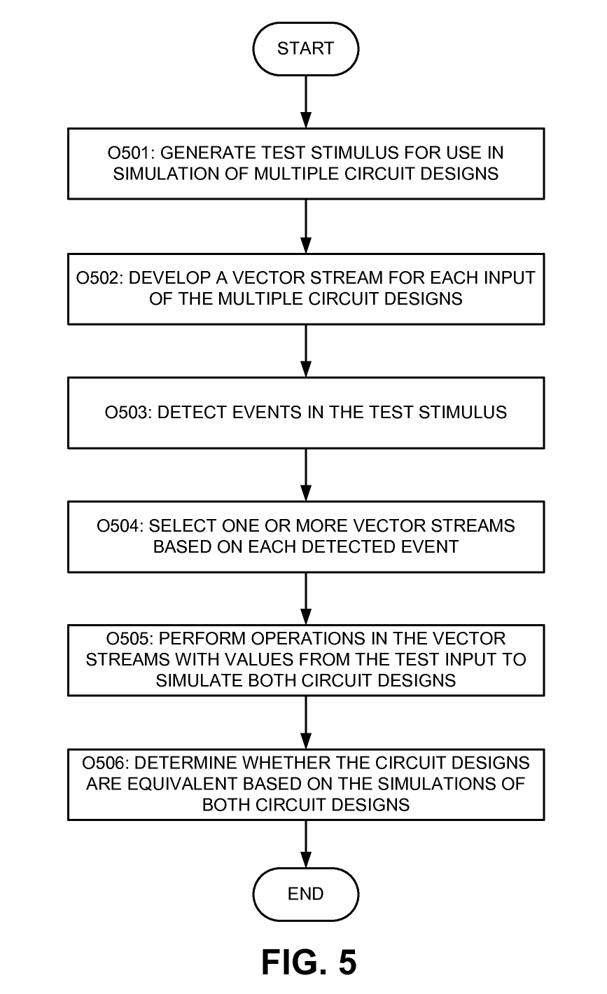

FIG. 4 illustrates an example vector generation unit 400 in an equivalence check tool according to various embodiments of the invention. Referring to FIG. 4, the vector generation unit 400 can include a vector stream control unit 410 to analyze circuit designs 402 to determine portions of those circuit designs affected by value changes at particular inputs, i.e., portions of those circuit designs having outputs that can depend on values of corresponding inputs. In some embodiments, the vector stream control unit 410 can generate vector streams 412 corresponding to each of the circuit design portions identified, for example, at least one vector steam 412 for each input of each circuit design 402. The vector stream 412 can be similar to vector streams 325 discussed above in FIG. 3.

The vector stream control unit 410 can provide the vector streams 412 to a vector stream storage unit 420, such as a memory device or system. In some embodiments, the vector stream storage unit 420 can be indexable by an event identification 404, i.e., the event identification 404 can identify a storage location in the vector stream storage unit 420 of a vector stream 412. In such an event, the vector stream storage unit 420 can receive the event identification 404 directly and output a vector stream 412 in response to the event identification 404. In other embodiments, the vector stream control unit 410 can receive the event identification 404, determine which vector stream to select in the vector stream storage unit 420, and prompt the vector stream storage unit 420 to output the selected vector stream 412.

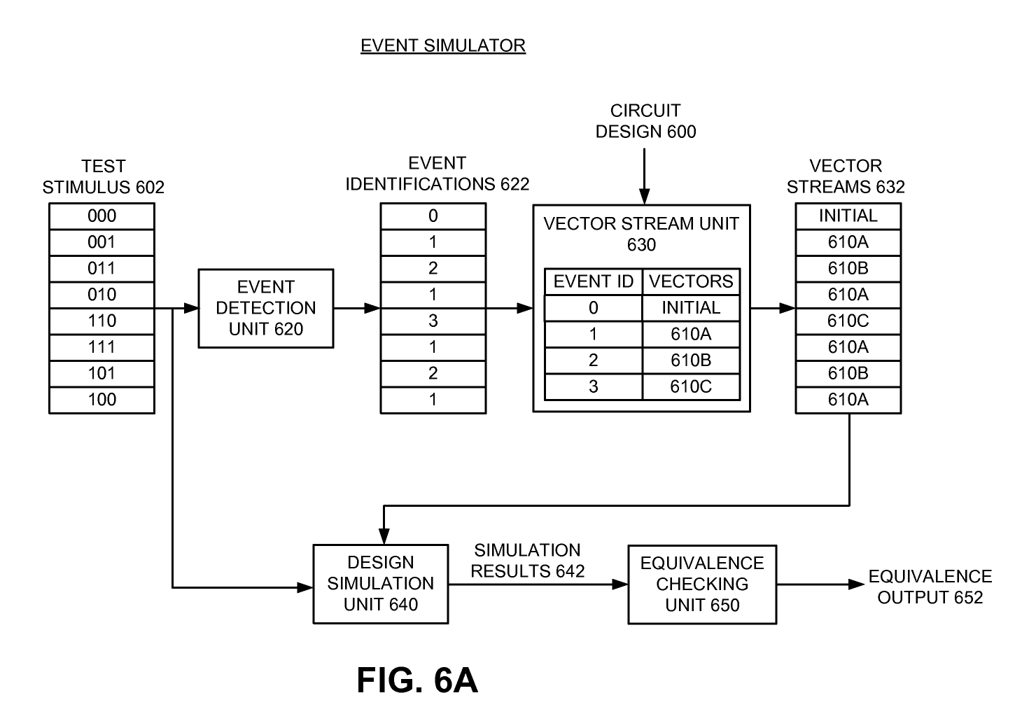

FIG. 5 illustrates a flowchart showing an example implementation of exhaustive event simulation for equivalence checking according to various embodiments of the invention. Referring to FIG. 5, in a block 501, the equivalence checking tool can generate test stimulus for use in simulation of multiple circuit designs. The multiple circuit designs can be different representations of a common design, for example, at different levels of abstraction, such as an RTL representation, a gate-level netlist representation, a physical design layout representation, or the like.

The test stimulus can include a series of test vectors, each having a set of bits corresponding to a set of inputs in each of the circuit designs. The test stimulus can include an exhaustive list of the test vectors, for example, every possible test vector for a given number of bits in those test vectors. The equivalence checking tool can generate the test vectors in a particular order, for example, in a standard binary counting order, such as 0, 1, 2, 3, etc., in an order having adjacent test vectors having one bit different, such as a grey code ordering scheme, or the like.

In a block 502, the equivalence checking tool can develop a vector stream for each input of the multiple circuit designs. The equivalence checking tool can analyze the circuit design, for example, on an input-by-input basis, to identify one or more portions of the circuit design that can depend on a value provided to a particular input, and then generate a vector stream of operational instructions for the equivalence checking tool to simulate. The vector streams can model the operations present in the identified portions of the circuit designs, and, in some cases, also identify their corresponding operands. The equivalence checking tool can arrange the vector streams, for example, in serial fashion, to allow the equivalence checking tool the ability to simulate the identified portion of the circuit designs with the test vectors as input to at least some of the operands.

In a block 503, the equivalence checking tool can detect events in test stimulus. In some embodiments, the events can be value changes between adjacent test vectors in the test stimulus. In a block 504, the equivalence checking tool can select one or more vector streams based on each detected event. For example, since each test vector includes a set of bits correlated to a corresponding set of inputs to each circuit design, a detected change in first bit between adjacent test vectors can indicate a first input corresponding to the first bit will receive a different value. Based on this knowledge, the equivalence checking tool can select one or more vector streams modeling operations in the circuit designs that could be affected by a value change to the first input.

In a block 505, the equivalence checking tool can perform operations in the vector streams with values from the test input to simulate both circuit designs. The equivalence checking tool can combine the results of the performed operations with results corresponding to other portions of the circuit designs that were left unaltered by the simulation of the vector stream.

In a block 506, the equivalence checking tool can determine whether the circuit designs are equivalent based on the simulations of both circuit designs. In some embodiments, the equivalence checking tool can review selected points of the simulation results, or comparison points, to determine whether they are the same and thus deem the circuit designs equivalent.

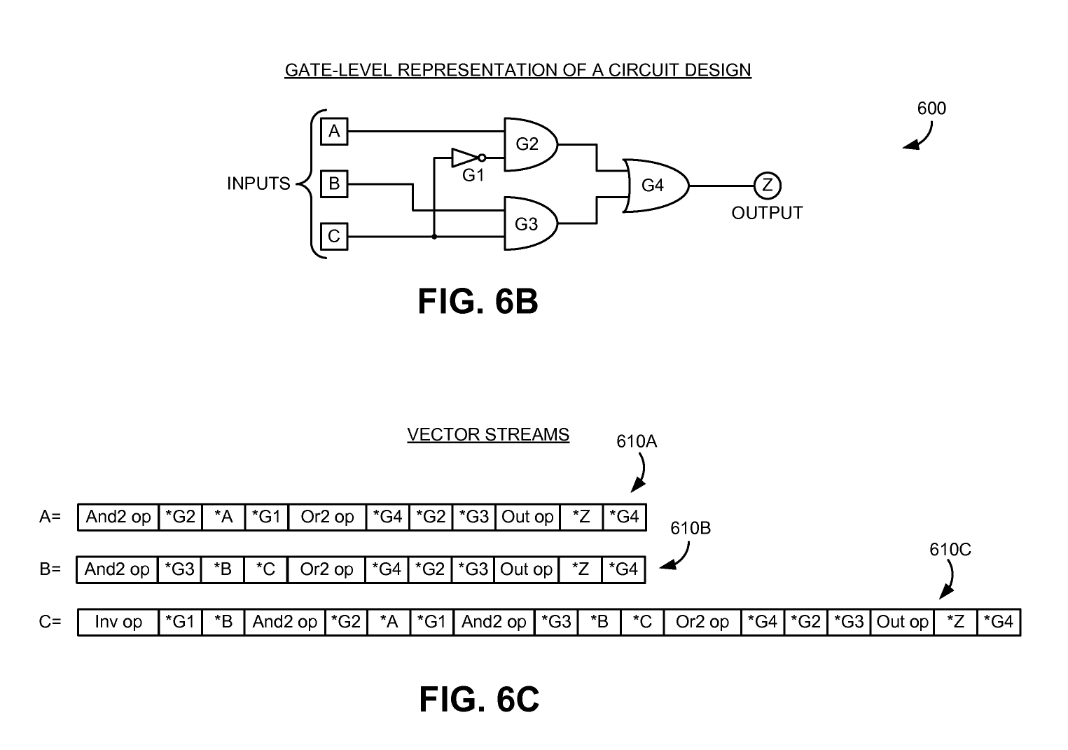

FIGS. 6A-6C illustrate an example implementation of exhaustive event simulation for equivalence checking according to various embodiments of the invention. Referring to FIG. 6A, an operational flow for the event simulator is shown. The operation flow can include an event detection unit 620 to receive test stimulus 602, which can be provided as a series of test vectors. In this example, the test vectors have 3-bits, one bit for each input of the circuit design 600. The event detection unit 620 can review the test vectors, for example, as they are received, to determine a different between a currently received test vector and a previously received test vector. The event detection unit 620 can generate event identifications 622 to identify a type of value change detected by the event detection unit 620, for example, which bit or bits where different from a previous test vector. In some embodiments, when there were no previous test vectors, the event detection unit 620 can generate a test vector that indicates the entire circuit design 600 should be simulated with the currently received test vector.

The operation flow can include a vector stream unit 630 to receive one or more circuit designs 604, analyze the circuit design 600 as shown below in FIGS. 6B and 6C to develop one or more vector streams 610A-610C. Referring to FIG. 6B, a gate-level representation of a circuit design 600 is shown, for example, as described in a netlist or other gate-level design file. The circuit design 600 can include multiple inputs A, B, and C, multiple logic gates G1, G2, G3, and G4, and an output Z. The logic gate G1 can be an inverter configured to receive a value from input B. The logic gate G2 can be 2-input AND gate, which can receive values from input A and an output of logic gate G1. The logic gate G3 can be 2-input AND gate, which can receive values from inputs B and C. The logic gate G4 can be a 2-input OR gate, which can receive values from outputs of logic gates G2 and G3, and output a value to the output Z.

Referring to FIG. 6C, an event simulator can analyze the functionality, structure, interconnections, or the like, of the circuit design 600 and identify a first portion of the circuit design 600 that depends on a value of input A, identify a second portion of the circuit design 600 that depends on a value of input B, and identify a third portion of the circuit design 600 that depends on a value of input C. Once identified, the event simulator can generate vector streams 610A-610C corresponding to the identified circuit design portions. The vector streams 610A-610C can include operational instructions having semantics and syntax that, when executed by the event simulator, for example, in a serial fashion, can allow the event simulator to simulate the identified portion of the circuit design with the values at the inputs A, B, and C.

The vector stream 610A can include multiple fields, for example, read from left-to-right, describing various operations, and optionally their corresponding operands, for the event simulator to perform during simulation of the circuit design 600. In some embodiments, the vector stream 610A can describe operations with several fields, for example, a first or left-most field can identify an operation type, a next field can identify a name or identifier of the operation, and any following fields can describe one or more operands input to the operation.

Referring back to FIG. 6A, the vector stream unit 630 can receive a stream of event identifications 622 from the event detection unit 620 and select corresponding vector streams 610A-610C in response to each of the event identifications 622. For example, when the event identification 622 indicates a certain bit had a changed value, such as bit 1, the vector stream unit 630 can select the vector stream 610A corresponding to the same input as bit 1. In some embodiments, when the event identification 622 indicates all of the bits are new, for example, there was no previous simulation with the test stimulus 602, the vector stream unit 630 can select an initial INIT vector stream, which can simulate the entire circuit design 600.

The operation flow can include a design simulation unit 640 to receive the test stimulus 602 and the vector streams 632 selected based on value changes in the test stimulus 602. The design simulation unit 640 can pair each test vector in the test stimulus 602 to one or more of the vector streams 632 that were selected due to value changes by the corresponding test vector. The design simulation unit 640 can simulate the test vector-vector stream pairs and provide the simulation results 642 to an equivalence checking unit 650. The equivalence checking unit 650 can compare the simulation results 642 for the multiple circuit designs 604, and generate an equivalence output 652 to indicate whether the multiple circuit designs 604 are equivalent to each other.

The vector stream 610A can describe three different operations, with three different field groupings, the beginning of each demarked by an initiation of a operation type field. For example, a first or left-most field in the vector stream 610A can identify a 2-input AND operation, the next field names the 2-input AND operation G2, while the remaining two fields in the grouping identify the two operands A and G1 to the 2-input AND operation G2. Since operand G1 identifies an output of another logic gate, which the vector stream 610A does not simulate, the event simulator can utilize the output value of gate G1 retained from a previous simulation of the circuit design 600. The second operational grouping can identify a 2-input OR operation, the next field names the 2-input OR operation G4, while the remaining two fields in the grouping identify the two operands G2 and G3 to the 2-input OR operation G4. Since operand G3 identifies an output of another logic gate, which the vector stream 610A does not simulate, the event simulator can utilize the output value of gate G3 retained from a previous simulation of the circuit design 600. The last operation in vector stream 610A can identify an output operation, the next field names the output operation Z, while the remaining field in the grouping identifies the value G4 to be output. The vector streams 610B and 610C can model operations for inputs B and C, respectively, with similar syntax and semantics as described above with the vector stream 610A.

Although this application discloses simulation techniques that can be implemented in an exhaustive equivalency check application, the simulation techniques can be implemented as stand-alone simulators or in other applications, which may or may not include an exhaustive list of test vectors.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
developing, by a computing system, a vector stream for each input of a circuit design, wherein each vector stream is configured to identify one or more operations in the circuit design having an output that depends on a corresponding input of the circuit design;
selecting, by the computing system, different vector streams to utilize for simulation of the circuit design based on value changes in a series of test vectors; and
simulating, by the computing system, the circuit design by performing operations identified by the selected vector streams with values from the corresponding test vectors.

2. The method of claim 1, further comprising:
comparing, by the computing system, results from the simulation of the circuit design with simulation results corresponding to another circuit design; and
determining, by the computing system, whether the circuit designs are equivalent based on the comparison.

3. The method of claim 1, further comprising generating, by the computing system, the series of test vectors, each test vector having a set of bits corresponding to a set of inputs in the circuit design.

4. The method of claim 1, further comprising:
detecting, by the computing system, value changes in the series of test vectors by comparing adjacent test vectors in the series of test vectors; and
generating, by the computing system, event identifications to indicate which of the bits in the adjacent test vectors had value changes.

5. The method of claim 4, wherein each pair of adjacent test vectors has only one bit value different from each other.

6. The method of claim 4, wherein selecting the different vector streams to utilize for simulation of the circuit design is performed in response to the event identifications.

7. The method of claim 1, wherein simulating the circuit design further comprises combining results from the performance of operations identified by the selected vector streams with results from simulating a correspondingly previous selected vector stream.

8. A system comprising:
a pattern generator configured to generate a series of test vectors, each test vector having a set of bits corresponding to a set of inputs in a circuit design; and
an event simulator configured to develop a vector stream for each input of the circuit design, wherein each vector stream is configured to identify one or more operations in the circuit design having an output that depends on a corresponding input of the circuit design, wherein the event simulator is configured to simulate the circuit design by selectively performing the operations in different vector streams based, at least in part, on value changes in the series of test vectors.

9. The system of claim 8, further comprising an equivalency checking unit configured to compare results from the simulation of the circuit design with simulation results corresponding to another circuit design, and determine whether the circuit designs are equivalent based on the comparison.

10. The system of claim 8, wherein the event simulator is configured to detect value changes in the series of test vectors by comparing adjacent test vectors in the series of test vectors, and generate event identifications to indicate which of the bits in the adjacent test vectors had value changes.

11. The system of claim 10, wherein the event simulator is configured to select the different vector streams to utilize for simulation of the circuit design in response to the event identifications.

12. The system of claim 8, wherein each pair of adjacent test vectors has only one bit value different from each other.

13. The system of claim 8, wherein the bits in the test vectors are correlated with inputs of the circuit design based, at least in part, on sizing of the vectors streams corresponding to the inputs and a frequency of the value changes for the bits in the test vectors.

14. An apparatus comprising at least one computer-readable memory device storing instructions configured to cause a computing system to perform operations comprising:
determining, for each input of a circuit design, a portion of the circuit design having an output that depends on a value for a corresponding input;
identifying inputs of the circuit design that correspond to value changes in a series test vectors; and
separately simulating the portions of the circuit design based, at least in part, on the inputs of the circuit design identified by the value changes in the series of test vectors.

15. The apparatus of claim 14, wherein the instructions are configured to cause the computing system to perform operations further comprising combining results from simulating the portions of the circuit design with results from the previous circuit design simulation corresponding to other portions of the circuit design, which generates simulation results for the circuit design.

16. The apparatus of claim 15, wherein the instructions are configured to cause the computing system to perform operations further comprising:
comparing the simulation results for the circuit design with simulation results for another circuit design; and
determining whether the circuit designs are equivalent based on the comparison.

17. The apparatus of claim 14, wherein the instructions are configured to cause the computing system to perform operations further comprising generating the series of test vectors, each test vector having a set of bits corresponding to a set of inputs in the circuit design.

18. The apparatus of claim 17, wherein each pair of adjacent test vectors has only one bit value different from each other.

19. The apparatus of claim 17, wherein the bits in the test vectors are correlated with inputs of the circuit design based, at least in part, on sizes of the portions of the circuit design corresponding to the inputs and a frequency of the value changes for the bits in the test vectors.

20. The apparatus of claim 14, wherein the instructions are configured to cause the computing system to perform operations further comprising:
generating a vector stream for each portion of the circuit design determined to correspond to at least one of the inputs of the circuit design; and
selecting different vector streams to utilize for simulation of the circuit design based on the identified inputs.
